(19) United States
(12) Patent Application Publication
(10) Pub. No.: US 2006/0069548 A1
(43) Pub. Date: Mar. 30, 2006

(54) Audio output apparatus and audio and video output apparatus

(76) Inventor: Masaki Matsuura, Iwaki-city (JP)

Correspondence Address: BRINKS HOFER GILSON & LIONE, P.O. BOX 10395, CHICAGO, IL, 60610, US

(21) Appl. No.: 11/214,464

(22) Filed: Aug. 29, 2005

(30) Foreign Application Priority Data
Sep. 13, 2004 (JP) 2004-265095

(51) Int. Cl. G10L 19/00

(52) U.S. Cl. 704/200.1

(57) ABSTRACT

The present invention relates to an audio output apparatus and an audio and video output apparatus which enable a user to recognize output speech even when ambient noise increases or when a loud irregular noise occurs. The audio and video output apparatus includes an audio unit for supplying sound including speech to a speaker; a video unit for supplying video images to a monitor; a text generation unit for generating text corresponding to speech; a noise detection unit for detecting noise; and a display control unit for superimposing text corresponding to speech on a video image and causing the monitor to display the resultant image when the level of the detected noise is higher than a preset level. Thus, the user is prevented from missing speech produced by the apparatus.

### BACKGROUND

1. Technical Field

The present invention relates to audio output apparatuses and audio and video output apparatuses and, more particularly, to an audio output apparatus and an audio and video output apparatus which display text (character strings) corresponding to speech when ambient noise increases and the speech is inaudible.

2. Background Information

An environment in a vehicle interior sound space changes from moment to moment depending on a driving state of a vehicle. In some cases, ambient noise, such as road noise, increases during DVD or CD playback on a sound system in the vehicle. When the ambient noise increases, the noise interferes with sound (speech) produced from the sound system, so that the sound is inaudible. To prevent the interference, conventionally, ambient noise is detected in a vehicle cabin and the volume of a sound system is controlled depending on the level of the ambient noise (refer to, e.g., Japanese Unexamined Patent Application Publication No. 6-78390).

In the above-mentioned related art, the total amount of sound increases depending on the ambient noise level. However, if a DVD has a low volume level at times, the total volume of the sound system is not increased correspondingly. Therefore, speech at a low volume is made inaudible by ambient noise. In some cases, a loud irregular noise occurs depending on road conditions. If such a large irregular noise occurs, speech may be inaudible at that time.

Circumstances during DVD playback have been described above. The above-mentioned circumstances are not limited to DVD playback. In receiving a television broadcasting service, speech at a low volume is similarly made inaudible by ambient noise, and speech is also inaudible upon the occurrence of a loud irregular noise.

Regarding an on-vehicle navigation system, when a vehicle approaches an intersection, the system may perform speech guidance, i.e., informing a driver of the direction of travel by speech. If ambient noise occurs during speech guidance, this speech may be made inaudible by the ambient noise.

In addition, in a case where a driver receives traffic information or another information item by radio, when ambient noise occurs, the driver may fail to hear the information.

### BRIEF SUMMARY

Accordingly, it is an object of the present invention to enable a user to recognize speech generated when ambient noise increases or when a loud irregular noise occurs.

According to the present invention, in consideration of the above-mentioned circumstances, there is provided an audio output apparatus for producing sound including speech, the apparatus including: a noise detection unit for detecting noise; and a display control unit for displaying text corresponding to speech when the level of the detected noise is higher than a preset level.

The present invention further provides an audio and video output apparatus for producing sound including speech and video images, the apparatus including: an audio unit for supplying sound including speech to a speaker; a video unit for supplying video images to a monitor; a text generation unit for generating text corresponding to the speech; a noise detection unit for detecting noise; and a display control unit for superimposing text corresponding to speech on a video image and causing the monitor to display the resultant image when the level of the detected noise is higher than a preset level.

The present invention further provides an audio and video output apparatus for playing back sound including speech and video images recorded on a recording medium and producing the sound and the video images, the apparatus including: a separation unit for separating video signals, sub-picture signals, and audio signals recorded on the recording medium; an audio unit for supplying the audio signals to a speaker; a video unit for supplying the video signals to a monitor; a noise detection unit for detecting noise in a sound space; and a display control unit for superimposing a subtitle included in the sub-picture signals on a video image and causing the monitor to display the resultant image when the level of the detected noise is higher than a preset level.

The present invention further provides an audio and video output apparatus for receiving television signals and producing sound including speech and video images, the apparatus including: a separation unit for separating audio signals and video signals from the received signals; an audio unit for supplying the audio signals to a speaker; a video unit for supplying the video signals to a monitor; a noise detection unit for detecting noise in a sound space; a text generation unit for generating text corresponding to speech using the audio signals; and a display control unit for superimposing text corresponding to speech on a video image and causing the monitor to display the resultant image when the level of the detected noise is higher than a preset level.

The present invention further provides an audio and video output apparatus for producing guidance speech and map images, the apparatus including: a guidance speech storage unit for storing guidance speech data; a speech generation unit for generating guidance speech using predetermined guidance speech data and supplying the generated speech to a speaker; a video unit for supplying map images to a monitor; a text generation unit for generating text corresponding to guidance speech using the guidance speech data; a noise detection unit for detecting noise; and a display control unit for superimposing text corresponding to guidance speech on a map image and causing the monitor to display the resultant image when the level of the detected noise is higher than a preset level.

According to the present invention, when ambient noise, such as road noise, increases, text corresponding to speech is displayed. If a television program or a DVD originally has a low volume level, advantageously a user does not fail to comprehend the speech, such as spoken lines.

Further, according to the present invention, even when the user fails to hear speech upon the occurrence of a sudden loud noise, text corresponding to speech of a predetermined length produced around the time of the occurrence of the noise are displayed using a subtitle or by any other means. Advantageously, the user does not fail to comprehend the speech.

Further, according to the present invention, in a navigation system, even when a user fails to hear guidance speech because of ambient noise, text corresponding to the guidance speech is displayed. Advantageously, a user can easily comprehend the guidance.

In addition, according to the present invention, in an audio output apparatus for producing speech, such as a radio, when a user fails to hear speech regarding, e.g., traffic information, because of ambient noise, text corresponding to the speech is displayed. Advantageously, a user can easily comprehend the traffic information.

### BRIEF DESCRIPTION OF THE DRAWINGS

FIG. 1 is a general block diagram of an audio output apparatus according to a first embodiment of the present invention;

FIG. 2 is a general block diagram of an audio and video output apparatus according to a second embodiment of the present invention;

FIGS. 3A and 3B show display examples according to the present invention during DVD playback;

FIG. 4 is a block diagram according to the first embodiment of the present invention;

FIG. 5 is a block diagram of an ambient noise detector;

FIG. 6 is a block diagram according to the second embodiment of the present invention:

FIG. 7 is a block diagram according to a third embodiment of the present invention; and

FIG. 8 is a block diagram according to a fourth embodiment of the present invention.

### DETAILED DESCRIPTION OF THE PREFERRED EMBODIMENTS

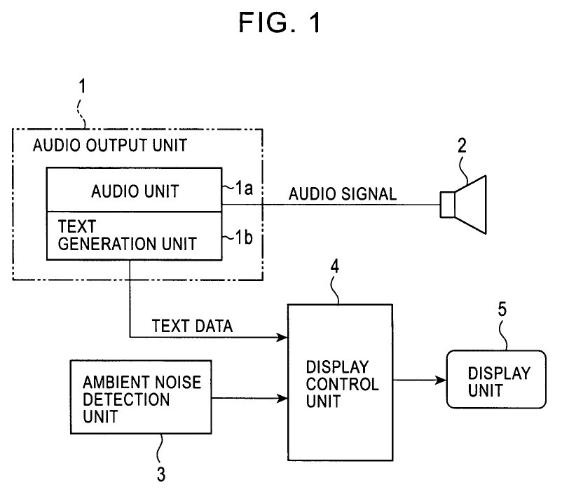

FIG. 1 is a diagram explaining an audio output apparatus according to a first embodiment of the present invention. An audio output unit 1 includes an audio unit 1a and a text generation unit 1b. The audio unit 1a supplies an audio signal to a speaker 2 to generate sound including speech. The text generation unit 1b generates data regarding text corresponding to speech and supplies the data to a display control unit 4. An ambient noise detection unit 3 detects ambient noise in a sound space. When the level of the detected noise is higher than a preset level, the display control unit 4 causes a display unit 5 to display text corresponding to speech.

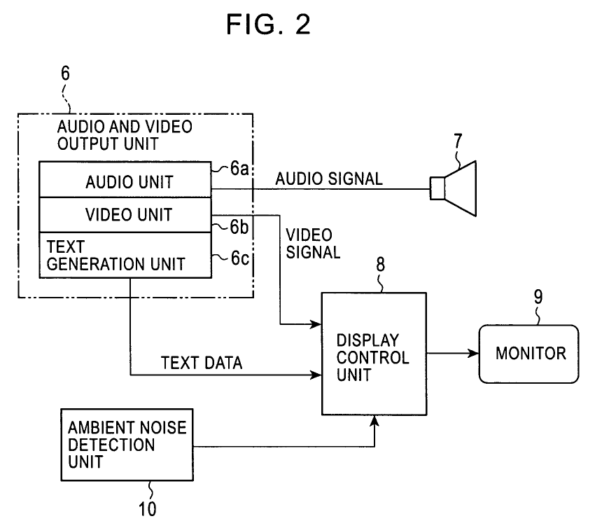

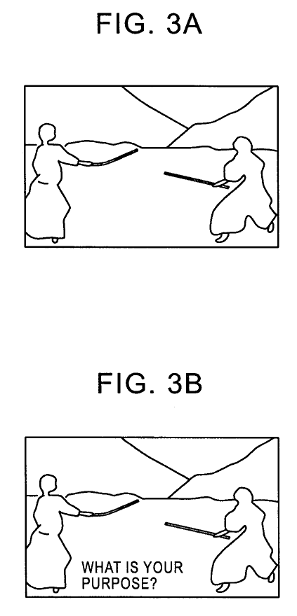

FIG. 2 is a diagram explaining an audio and video output apparatus according to a second embodiment of the present invention. An audio and video output unit 6 includes an audio unit 6a, a video unit 6b, and a text generation unit 6c. The audio unit 6a supplies an audio signal to a speaker 7 to generate sound (speech). The video unit 6b supplies a video signal to a display control unit 8 which causes a monitor 9 to display a video image. The text generation unit 6c generates data regarding text corresponding to speech, e.g., a subtitle, and supplies the data to the display control unit 8. An ambient noise detection unit 10 detects ambient noise in a sound space. When the level of the detected noise is higher than a preset level, the display control unit 8 causes the monitor 9 to display text (subtitle) corresponding to speech such that the text is superimposed on a video image. FIGS. 3A and 3B show display examples according to the present invention during DVD playback. In viewing a movie without subtitles as shown in FIG. 3A, when ambient noise increases or, alternatively, when a loud irregular noise occurs, the display control unit 8 causes the monitor 9 to display a subtitle corresponding to speech at that time such that the subtitle is superimposed on a video image as shown in FIG. 3B.

As mentioned above, according to the present invention, even when ambient noise, such as road noise, increases or, alternatively, when a loud irregular noise suddenly occurs, text corresponding to speech of a predetermined length generated around the time of the occurrence of the noise is displayed using a subtitle or by any other means. Thus, a viewer does not fail to comprehend the speech.

### First Embodiment

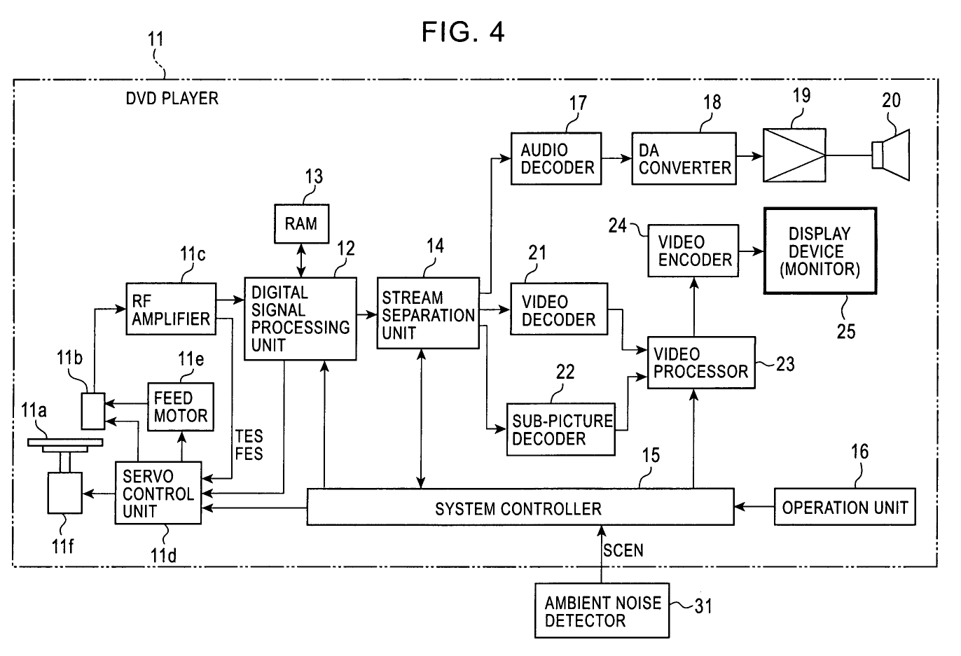

According to the first embodiment, the present invention is applied to an on-vehicle DVD player. FIG. 4 is a block diagram of an on-vehicle DVD player 11 according to the first embodiment of the present invention. An ambient noise detector 31 for detecting ambient noise is connected to the DVD player 11 such that ambient noise is detected in a vehicle interior sound space.

In the DVD player 11, an optical pickup 11b reads out a signal from a DVD-Video disc 11a and supplies the signal to an RF amplifier 11c. The RF amplifier 11c amplifies the signal and supplies the resultant signal to the next stage. In addition, the RF amplifier 11c generates a tracking error signal TES and a focusing error signal FES and supplies these signals to a servo control unit 1d. The servo control unit 11d drives a feed motor 11e using the tracking error signal TES to perform tracking servo control. In addition, the servo control unit 1d moves the optical pickup 11b in the radial direction of the disc 11a and positions the optical pickup 11b in a predetermined position on the basis of an instruction from a system controller 15. Further, the servo control unit 1d drives an actuator based on the focusing error signal FES to perform focusing servo control such that the focal point of the optical pickup 11b is positioned on the surface of the disc (the optical pickup 11b is focused on the disc surface). In addition, the servo control unit Id controls a spindle motor 11f to rotate at constant speed.

A digital signal processing unit 12 demodulates DVD modulated signals, performs error correction and digital authentication, and transfers a bit stream (DVD data) using a RAM 13. A stream separation unit 14 analyzes a DVD data stream and supplies navigation data to the system controller 15. In addition, the stream separation unit 14 separates the bit stream into video data, serving as video images corresponding to a video title selected by an operation unit 16, sub-picture data regarding subtitles in a selected language, and audio data corresponding to the selected language, and then outputs the separated data.

An audio decoder 17 decompresses compressed audio data into PCM audio data and outputs the resultant data. A digital-to-analog (DA) converter 18 converts the PCM audio data into analog data and supplies the data to a speaker 20 through an amplifier 19. A video decoder 21 decodes MPEG video data, serving as video images, and outputs the data. A sub-picture decoder 22 decompresses compressed sub-picture data regarding subtitles and outputs the data. A video processor 23 superimposes the sub-picture data on the video data and supplies the resultant data to a video encoder 24. The video encoder 24 encodes the received data into NTSC signals or PAL signals, converts the signals, which are digital, into analog signals, and supplies the signals to a display device (monitor) 25, thus displaying video images.

For example, to play back a DVD of a Japanese movie, “SPEECH: JAPANESE” and “SUBTITLE: OFF” are set in the operation unit 16 and playback is then started. Consequently, a viewer can view video images without subtitles and enjoy the movie in the Japanese language. Under the above condition, when ambient noise continuously increases, or when a loud irregular noise occurs, the ambient noise detector 31 detects the noise and supplies a speech-to-character (text) output enable signal SCEN to the system controller 15. Thus, the system controller 15 instructs the stream separation unit 14 to supply data concerning Japanese subtitles to the sub-picture decoder 22. The sub-picture decoder 22 decodes the supplied subtitle data and supplies the data to the video processor 23. The video processor 23 superimposes the supplied subtitle data on video data and in turn supplies the resultant data to the video encoder 24, thus displaying the resultant data on the monitor 25. Consequently, as shown in FIG. 3B, a subtitle corresponding to speech generated when the noise increases, i.e., “What is your purpose?” is displayed on the monitor 25. In other words, even when ambient noise, such as road noise, increases or when a loud irregular noise suddenly occurs, text (subtitle) corresponding to speech of a predetermined length generated around the time of the occurrence of the noise is displayed. Thus, the viewer does not fail to comprehend the speech.

When ambient noise is not detected, the system controller 15 instructs the stream separation unit 14 to stop supplying data concerning Japanese subtitles, so that the display of subtitles is stopped.

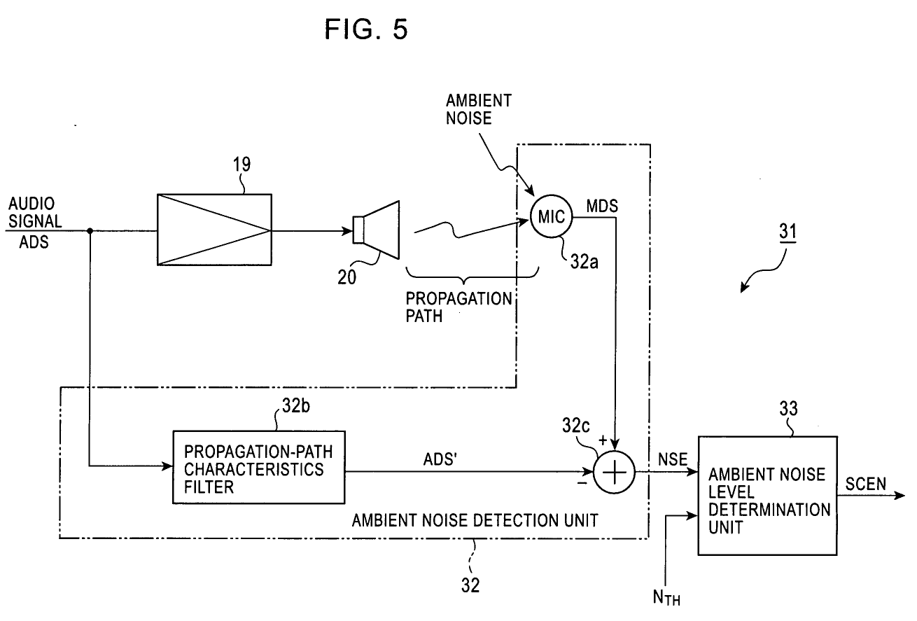

FIG. 5 is a block diagram of the ambient noise detector 31, which includes an ambient noise detection unit 32 and an ambient noise level determination unit 33. The ambient noise detection unit 32 includes a microphone 32a, a filter (propagation-path characteristics filter) 32b, and an arithmetic unit 32c. The microphone 32a detects sound in a vehicle interior sound space. The propagation-path characteristics filter 32b simulates the characteristics of a propagation path from the speaker 20 to the microphone 32a. The propagation-path characteristics filter 32b receives an audio signal ADS. The arithmetic unit 32c subtracts an output signal ADS′ of the propagation-path characteristics filter 32b from a microphone detection signal MDS to produce an ambient noise signal NSE in the sound space and then outputs the signal NSE.

Since the propagation-path characteristics filter 32b simulates the characteristics of the propagation path, the output signal ADS′ thereof is identical to an audio signal detected by the microphone 32a. Therefore, the output signal ADS′ of the propagation-path characteristics filter 32b is subtracted from the microphone detection signal MDS, thus obtaining the ambient noise signal NSE. The ambient noise level determination unit 33 compares the level N of the ambient noise signal NSE to a preset level NTH. If N>NTH, the ambient noise level determination unit 33 generates a speech-to-character output enable signal SCEN and supplies the signal to the system controller 15. On the condition that N>NTH, the system controller 15 causes the monitor to display a subtitle.

### Second Embodiment

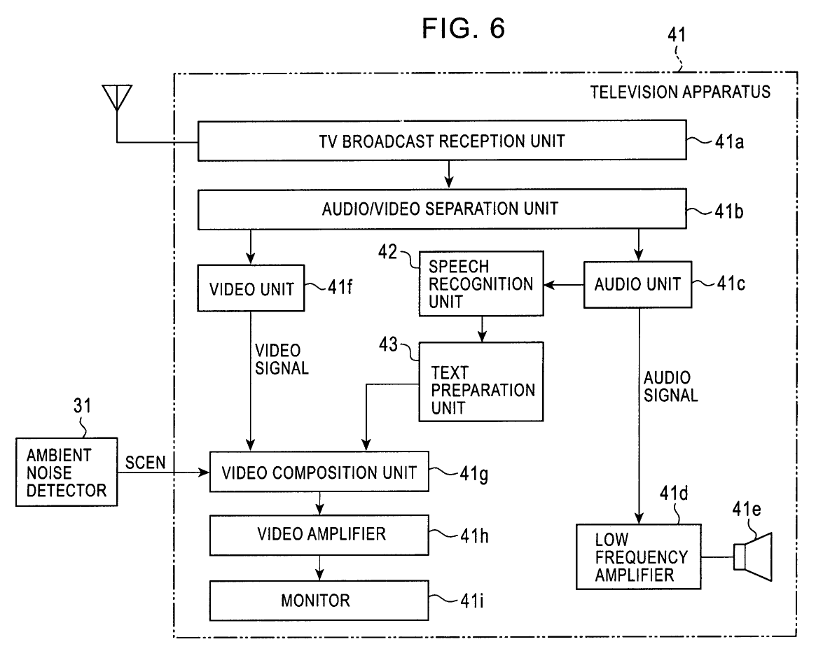

According to the second embodiment, the present invention is applied to an on-vehicle television apparatus. FIG. 6 is a block diagram of an on-vehicle television apparatus 41 according to the second embodiment of the present invention. The television apparatus 41 is connected to the ambient noise detector 31 shown in FIG. 5 such that ambient noise is detected in a vehicle interior sound space.

In the television apparatus 41, a TV broadcast reception unit 41a high-frequency amplifies a TV signal into an audio video intermediate frequency (IF) signal. An audio/video separation unit 41b separates the audio video IF signal into an audio IF signal component and a video IF signal component. An audio unit 41c amplifies the audio IF signal component, detects an FM signal to obtain an audio signal, and supplies the audio signal to a low frequency amplifier 41d. The signal is then supplied to a speaker 41e. A video unit 41f amplifies the video IF signal component, detects a video signal, and supplies the video signal to a video composition unit 41g. The signal is in turn supplied to a video amplifier 41h and is then supplied to a monitor 41i, thus displaying a video image.

Simultaneously with the above processing, a speech recognition unit 42 executes speech recognition processing using the audio signal supplied from the audio unit 41c and supplies a result of the recognition to a text preparation unit 43. On the basis of the recognition result, the text preparation unit 43 produces data concerning text corresponding to speech, generates image data of characters constituting the text, and supplies the image data to the video composition unit 41g. Normally, the video composition unit 41g does not combine image data regarding characters supplied from the text preparation unit 43 with video data. When ambient noise increases, the video composition unit 41g combines character image data with video data, and the monitor 41i displays the resultant data.

In other words, in a normal TV reception and display mode, when ambient noise continuously increases for a predetermined time or a loud irregular noise occurs, the ambient noise detector 31 supplies a speech-to-character output enable signal SCEN to the video composition unit 41g. When loud noise occurs, therefore, the video composition unit 41g combines text image (subtitle) data supplied from the text preparation unit 43 with video data, and the monitor 41i displays the combined data.

Consequently, a subtitle corresponding to speech generated around the time when noise increases, e.g., “What is your purpose?” is displayed on the monitor 41i as shown in FIG. 3B. In other words, even when ambient noise, such as road noise, increases, or when a loud irregular noise suddenly occurs, text corresponding to speech of a predetermined length generated around the time of the occurrence of the noise is displayed. Advantageously, a viewer does not fail to comprehend the speech.

### Third Embodiment

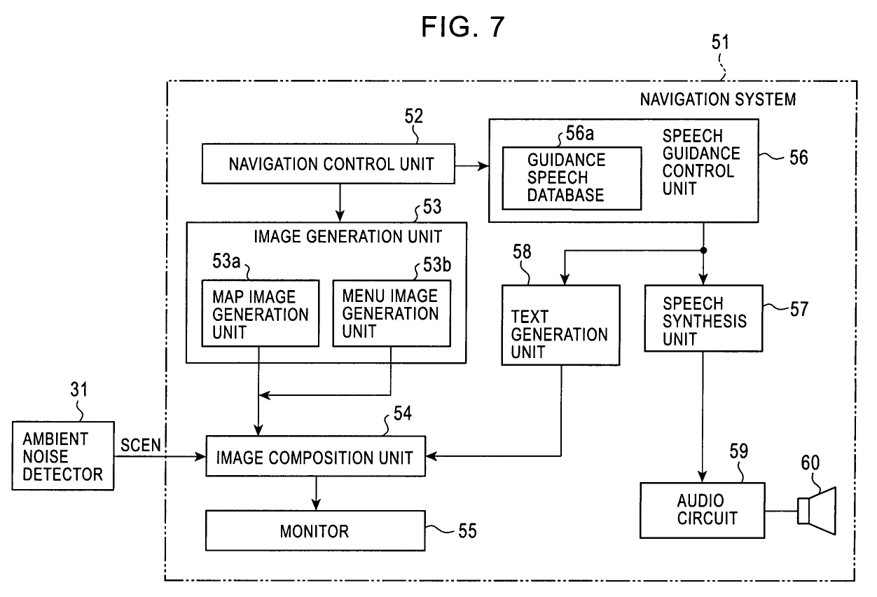

According to a third embodiment, the present invention is applied to an on-vehicle navigation system. FIG. 7 is a block diagram of an on-vehicle navigation system 51 according to the third embodiment of the present invention. The navigation system 51 is connected to the ambient noise detector 31 shown in FIG. 5 such that ambient noise is detected in a vehicle interior sound space.

In the navigation system 51, a navigation control unit 52 controls a monitor 55 to display a map of an area in the vicinity of the vehicle and also determines a route to a destination to perform navigation control. In an image generation unit 53, a map image generation unit 53a generates map data for an area in the vicinity of the vehicle and navigation route image data in accordance with an instruction from the navigation control unit 52. A menu image generation unit 53b generates menu image data in accordance with an instruction from the navigation control unit 52. The image generation unit 53 appropriately combines the map image data, the navigation route image data, and the menu image data and supplies the resultant data to an image composition unit 54, so that a map image and a menu image are displayed on the monitor 55.

As the vehicle approaches an intersection, the navigation control unit 52 executes speech guidance control to generate a voice message regarding the direction of travel at the intersection (e.g., tuning right or left, or going straight) at a point when the vehicle is 300 meters from the intersection and a point when the vehicle is 100 meters away. In other words, when the vehicle approaches an intersection, the navigation control unit 52 instructs a speech guidance control unit 56 to perform predetermined speech guidance. In order to produce the instructed guidance speech, the speech guidance control unit 56 retrieves guidance speech data from a guidance speech database 56a and supplies the data to a speech synthesis unit 57 and a text generation unit 58.

The speech synthesis unit 57 synthesizes guidance speech using the supplied guidance speech data to generate signals of the synthesized guidance speech and supplies the signals to an audio circuit 59. The signals are in turn supplied to a speaker 60, thus outputting the guidance speech into a vehicle cabin.

The text generation unit 58 generates data regarding text corresponding to guidance speech using the supplied guidance speech data, generates image data regarding characters of the text, and supplies the data to the image composition unit 54. Normally, the image composition unit 54 does not combine character image data, corresponding to guidance speech, supplied from the text generation unit 58 with map image data. When ambient noise increases, the image composition unit 54 combines character image data with map image data, and the monitor 55 displays the resultant data.

In other words, during navigation control, when ambient noise increases or, alternatively, when a loud irregular noise occurs, the ambient noise detector 31 supplies a speech-to-character output enable signal SCEN to the image composition unit 54. In response to the signal, the image composition unit 54 combines image data with video data, the image data concerning text (subtitle) corresponding to guidance speech supplied from the text generation unit 58 upon the occurrence of the noise. The monitor 55 displays the combined data.

Consequently, even when ambient noise, such as road noise, increases or when a loud irregular noise suddenly occurs, text corresponding to guidance speech generated upon the occurrence of the noise is displayed. Advantageously, a driver does not miss the guidance speech.

### Fourth Embodiment

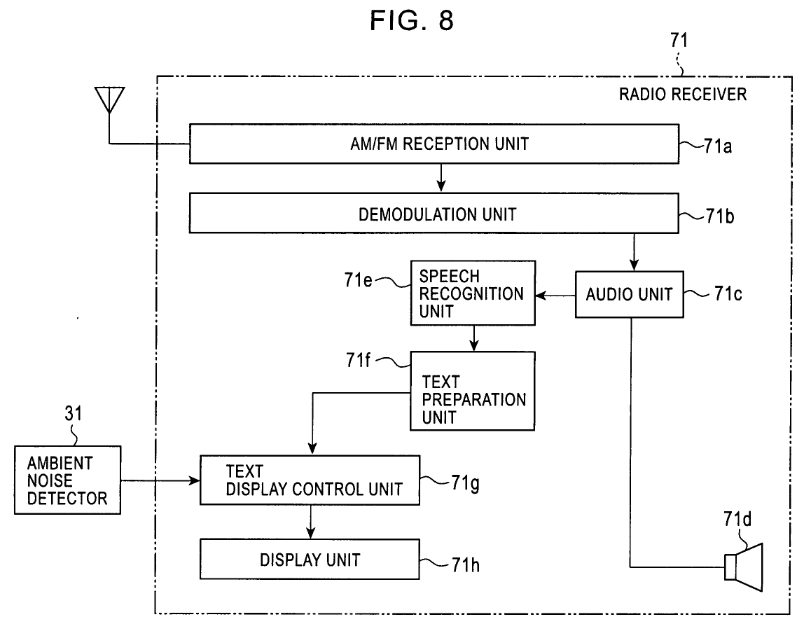

According to a fourth embodiment, the present invention is applied to an on-vehicle radio receiver. FIG. 8 is a block diagram of an on-vehicle radio receiver 71 according to the fourth embodiment of the present invention. The radio receiver 71 is connected to the ambient noise detector 31 shown in FIG. 5 such that ambient noise is detected in a vehicle interior sound space.

An AM/FM reception unit 71a high-frequency amplifies an AM or FM signal to produce an intermediate frequency (IF) signal. A demodulation unit 71b amplifies the IF signal, detects an AM/FM signal to obtain an audio signal, and supplies the audio signal to an audio unit 71c. The audio unit 71c performs volume control, low frequency amplification, and other audio processing on the audio signal and then supplies the resultant signal to a speaker 71d.

Simultaneously with the above processing, a speech recognition unit 71e executes speech recognition processing using the audio signal supplied from the audio unit 71c and supplies a result of the recognition to a text preparation unit 71f. On the basis of the recognition result, the text preparation unit 71f generates data regarding text corresponding to speech and image data regarding characters constituting the text and then supplies the data to a text display control unit 71g.

Generally, the text display control unit 71g does not output character image data supplied from the text preparation unit 71f. However, when ambient noise continuously increases or a loud irregular noise occurs upon receiving speech output such as traffic information, i.e., when a speech-to-character output enable signal SCEN is supplied from the ambient noise detector 31, the text display control unit 71g supplies character image data, which is obtained from the text preparation unit 71f, to a display unit 71h, thus displaying the character images.

Accordingly, even when ambient noise, such as road noise, increases or when a loud irregular noise suddenly occurs, the display unit 71h displays text corresponding to speech of a predetermined length generated around the time of the occurrence of the noise. Advantageously, a driver does not miss the speech, such as voice traffic information.

The above-mentioned embodiments relate to the case where ambient noise is detected in a vehicle cabin and text corresponding to speech is displayed on an on-vehicle display unit depending on the level of the detected ambient noise. However, the present invention is not limited to on-vehicle equipment.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

1. An audio output apparatus for producing sound including speech, the apparatus comprising:
a noise detection unit for detecting noise; and
a display control unit for displaying text corresponding to speech when the level of the detected noise is higher than a preset level.

2. The apparatus according to claim 1, further comprising:
a text generation unit for generating text corresponding to speech, wherein
when the detected noise level is higher than the preset level, the display control unit displays text generated by the text generation unit.

3. The apparatus according to claim 2, wherein the text corresponds to speech of a predetermined length generated around the time when the detected noise level is higher than the preset level.

4. The apparatus according to claim 1, wherein
the noise detection unit includes:
a microphone for detecting sound including speech in a sound space;
a filter for simulating the characteristics of a propagation path from a speaker to the microphone; and
an arithmetic unit for subtracting an output signal of the filter, which receives an audio signal, from a detection signal of the microphone to produce a signal corresponding to the noise in the sound space.

5. The apparatus according to claim 1, wherein the audio output apparatus is mounted in a vehicle and the noise detection unit detects noise in a vehicle cabin.

6. An audio and video output apparatus for producing sound including speech and video images, the apparatus comprising:
an audio unit for supplying sound including speech to a speaker;
a video unit for supplying video images to a monitor;
a text generation unit for generating text corresponding to speech;
a noise detection unit for detecting noise; and
a display control unit for superimposing text corresponding to speech on a video image and causing the monitor to display the resultant image when the level of the detected noise is higher than a preset level.

7. The apparatus according to claim 6, wherein the superimposed text corresponds to speech of a predetermined length generated around the time when the detected noise level is higher than the preset level.

8. The apparatus according to claim 6, wherein
the noise detection unit includes:
a microphone for detecting sound including speech in a sound space;
a filter for simulating the characteristics of a propagation path from the speaker to the microphone; and
an arithmetic unit for subtracting an output signal of the filter, which receives an audio signal, from a detection signal of the microphone to produce a signal corresponding to the noise in the sound space.

9. The apparatus according to claim 6, wherein the audio and video output apparatus is mounted in a vehicle, and the noise detection unit detects noise in a vehicle cabin.

10. An audio and video output apparatus for playing back sound including speech and video images recorded on a recording medium and producing the sound and the video images, the apparatus comprising:
a separation unit for separating video signals, sub-picture signals, and audio signals recorded on the recording medium;
an audio unit for supplying the audio signals to a speaker;
a video unit for supplying the video signals to a monitor;
a noise detection unit for detecting noise in a sound space; and
a display control unit for superimposing a subtitle included in the sub-picture signals on a video image and causing the monitor to display the resultant image when the level of the detected noise is higher than a preset level.

11. The apparatus according to claim 10, further comprising:
a video composition unit for combining the separated video signals and the sub-picture signals, wherein
when the level of the detected noise is higher than the preset level, the video composition unit combines a subtitle included in the sub-picture signals on a video image and causes the monitor to display the resultant image.

12. The apparatus according to claim 10, wherein
the noise detection unit includes:
a microphone for detecting sound including speech in the sound space;
a filter for simulating the characteristics of a propagation path from the speaker to the microphone; and
an arithmetic unit for subtracting an output signal of the filter, which receives an audio signal, from a detection signal of the microphone to produce a signal corresponding to the noise in the sound space.

13. The apparatus according to claim 10, wherein the audio and video output apparatus is mounted in a vehicle, and the noise detection unit detects noise in a vehicle cabin.

14. An audio and video output apparatus for receiving television signals and generating sound including speech and video images, the apparatus comprising:
a separation unit for separating audio signals and video signals from the received signals;
an audio unit for supplying the audio signals to a speaker;
a video unit for supplying the video signals to a monitor;
a noise detection unit for detecting noise in a sound space;
a text generation unit for generating text corresponding to speech using the audio signals; and
a display control unit for superimposing text corresponding to speech on a video image and causing the monitor to display the resultant image when the level of the detected noise is higher than a preset level.

15. The apparatus according to claim 14, wherein
the text generation unit includes:
a speech recognition unit for recognizing speech using the audio signals; and
a text preparation unit for outputting text corresponding to the recognized speech.

16. The apparatus according to claim 14, wherein
the display control unit includes a video composition unit for combining the generated text corresponding to speech with video images based on the separated video signals, and
when the detected noise level is higher than the preset level, the video composition unit combines text corresponding to speech with a video image, and the monitor displays the resultant image.

17. The apparatus according to claim 14, wherein
the noise detection unit includes:
a microphone for detecting sound including speech in the sound space;
a filter for simulating the characteristics of a propagation path from the speaker to the microphone; and
an arithmetic unit for subtracting an output signal of the filter, which receives an audio signal, from a detection signal of the microphone to produce a signal corresponding to a noise in the sound space.

18. The apparatus according to claim 14, wherein the audio and video output apparatus is mounted in a vehicle and the noise detection unit detects noise in a vehicle cabin.

19. An audio and video output apparatus for generating guidance speech and map images, the apparatus comprising:
a guidance speech storage unit for storing guidance speech data;
a speech generation unit for generating guidance speech using predetermined guidance speech data and supplying the generated speech to a speaker;
a video unit for supplying map images to a monitor;
a text generation unit for generating text corresponding to guidance speech using the guidance speech data;
a noise detection unit for detecting noise; and
a display control unit for superimposing text corresponding to guidance speech on a map image and causing the monitor to display the resultant image when the level of the detected noise is higher than a preset level.

20. The apparatus according to claim 19, wherein
the display control unit includes a video composition unit for combining a map image with the generated text corresponding to guidance speech, and
when the detected noise level is higher than the preset level, the video composition unit combines text corresponding to guidance speech with a map image, and the monitor displays the resultant image.

21. The apparatus according to claim 19, wherein
the noise detection unit includes:
a microphone for detecting sound including speech in a sound space;
a filter for simulating the characteristics of a propagation path from the speaker to the microphone; and
an arithmetic unit for subtracting an output signal of the filter, which receives an audio signal, from a detection signal of the microphone to produce a signal corresponding to the noise in the sound space.

22. The apparatus according to claim 19, wherein the audio and video output apparatus is mounted in a vehicle, and the noise detection unit detects noise in a vehicle cabin.
